(19) United States
(12) Patent Application Publication
(10) Pub. No.: US 2008/0236381 A1
(43) Pub. Date: Oct. 2, 2008

(54) POSITIONING CONTROL MECHANISM FOR DOUBLE-ACTING AIR CYLINDER

(75) Inventors: Takumi MATSUMOTO, Tsukubamirai-shi (JP); Kazuhiro Noguchi, Tsukubamirai-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SMC Corporation, Tokyo (JP)

(21) Appl. No.: 12/047,646

(22) Filed: Mar. 13, 2008

(30) Foreign Application Priority Data
Mar. 30, 2007 (JP) 2007-091488

(51) Int. Cl. F15B 15/18

(52) U.S. Cl. 91/42

(57) ABSTRACT

Between an air source and first and second pressure chambers of a double-acting main cylinder having a length measurement sensor for measuring an acting position of a piston, a first supply solenoid valve and a second supply solenoid valve are connected, respectively, while between the first and second pressure chambers and the atmosphere, a first exhaust solenoid valve and a second exhaust solenoid valve are connected, respectively. When a target acting position of the piston is inputted into a controller, the controller moves the piston to the target acting position so that a position measured by the length measurement sensor agrees with the target position by on-off controlling the solenoid valves. Upon reaching the target position, the piston is stopped and held in the stopped state by confining air within the pressure chambers.

### TECHNICAL FIELD

The present invention relates to a positioning control mechanism capable of optionally controlling the operating position of an air cylinder used for conveying, chucking, or fabricating a workpiece. In other words, the present invention relates to a positioning control mechanism capable of optionally changing or adjusting the point of a force applied to the workpiece, and in particular it relates to a control mechanism for a double-acting air cylinder.

### BACKGROUND ART

An actuator used for operations, such as conveying, chucking, and fabricating a workpiece, is operated by energy, such as pneumatic or hydraulic pressure and electricity. Among them, an electric actuator using the electric energy, although it is excellent in optionally changing or adjusting the point of a force applied to the workpiece, has a complicated structure, and it has especially complicated structure for obtaining linear motion. In order to obtain a large action force, the increase cannot be avoided in size and electric power, and for maintaining a predetermined stop position, the electric power supply must be continued meanwhile, so that the energy loss is also increased. Furthermore, when an action force is added to the load via a rod, etc., an impact is directly applied to a power transmission part of the actuator, so that not only the actuator suffers mechanical damage but also an excessive repulsive force may be applied to the load.

On the other hand, as a pneumatic actuator, an air cylinder has been well-known. The air cylinder, which converts energy of compressed air into linear motion, includes a double-acting air cylinder, in which by alternately supplying air into air chambers formed on both sides of a piston, the piston is reciprocally moved; and a single-acting air cylinder, in which by air supplied to or exhausted from an air chamber formed on one side of a piston and an urging force of a spring arranged on the other side, the piston is reciprocally moved. Any of these types is widely used for various operations because the linear motion can be obtained more readily than in the electric actuator.

However, generally, the operation stroke of the air cylinder is mechanically determined so as to reciprocally move between positions of advance and retreat ends defined by stoppers, so that it is difficult to change or adjust the operation stroke (operation positions). In particular, it is difficult to optionally change or adjust the operation stroke. Therefore, in general, air cylinders with different strokes are properly used depending on operation kinds.

### DISCLOSURE OF INVENTION

It is an object of the present invention to enable a double-acting air cylinder to optionally change or adjust its piston operation positions depending on operation kinds with a simple positioning control mechanism using a sensor and solenoid valves.

In order to achieve the object described above, a positioning control mechanism according to the present invention includes a double-acting main cylinder having a first pressure chamber and a second pressure chamber on both sides of a piston in that the piston is reciprocated by supplying air to these pressure chambers, a length measurement sensor for measuring an acting position of the piston along the entire stroke of the piston, an air supply section having an air source, a main air circuit interposed between the air supply section and the main cylinder, and a controller for electrically controlling the main air circuit.

The main air circuit includes a first air flow path and a second air flow path connecting between the air supply section and the first and second pressure chambers of the main cylinder, respectively; a two-port first supply solenoid valve and a two-port second supply solenoid valve connected to the first and second air flow paths so as to intersect them, respectively; and a two-port first exhaust solenoid valve and a two-port second exhaust solenoid valve connected to the first and second pressure chambers so as to intersect the flow paths between the atmosphere and the first and second pressure chambers, respectively. Also, the controller includes inputting means electrically connected to the length measurement sensor and the solenoid valves for inputting a target acting position of the piston, and the controller is configured to move the piston to the target acting position and stop it at the position by on-off controlling the solenoid valves on the basis of the compared results between target position information inputted by the inputting means and measured position information measured by the length measurement sensor: when the piston is advanced, the first supply solenoid valve and the second exhaust solenoid valve are turned on, while the second supply solenoid valve and the first exhaust solenoid valve are turned off, so that the air supply section is communicated with the first pressure chamber, and the second pressure chamber is opened to the atmosphere; when the piston is backed, the second supply solenoid valve and the first exhaust solenoid valve are turned on, while the first supply solenoid valve and the second exhaust solenoid valve are turned off, so that the air supply section is communicated with the second pressure chamber, and the first pressure chamber is opened to the atmosphere; and when the piston is stopped at the target position and maintained at the stopped position, the entire solenoid valves are turned off so as to confine air within the both pressure chambers.

According to the present invention, the positioning control mechanism may further include a double-acting slave cylinder with no length measurement sensor in addition to the main cylinder, and the slave cylinder may also be positioning-controlled via the main air circuit following the main cylinder by being connected to the main air circuit in parallel with the main cylinder.

Alternatively, the positioning control mechanism may further include a double-acting slave cylinder with no length measurement sensor and a slave air circuit connected to the slave cylinder to have the same configurations as those of the main air circuit, in addition to the main cylinder and the main air circuit, and the slave cylinder and the slave air circuit may also be positioning-controlled following the main cylinder and the main air circuit by being connected to the air supply section and the controller in parallel with the main cylinder and the main air circuit, respectively.

According to the present invention, preferably, the air supply section includes a regulator for maintaining the air pressure at a set pressure.

According to the present invention, acting positions of the piston in a double-acting air cylinder can be optionally changed or adjusted depending on operation kinds with the simple positioning control mechanism composed of the length measurement sensor, a plurality of the two-port solenoid valves, and the controller without any mechanical adjustment.

### BRIEF DESCRIPTION OF THE DRAWINGS

FIG. 1 is a connection diagram of a positioning control mechanism according to a first embodiment of the present invention.

FIG. 2 is a connection diagram of a positioning control mechanism according to a second embodiment of the present invention.

FIG. 3 is a connection diagram of a positioning control mechanism according to a third embodiment of the present invention.

### BEST MODE FOR CARRYING OUT THE INVENTION

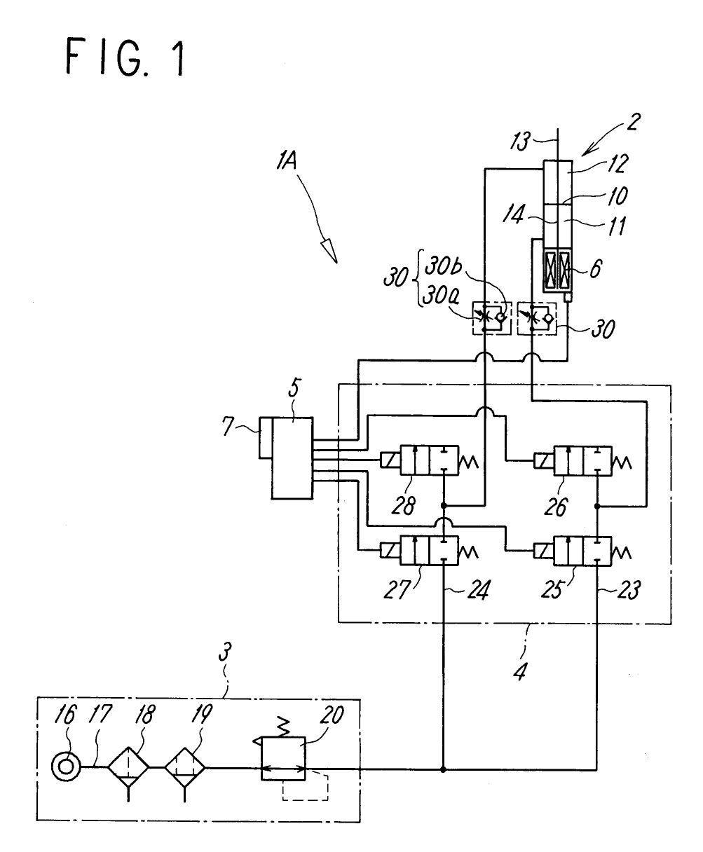

FIG. 1 shows a connection diagram with symbols of a positioning control mechanism for a double-acting air cylinder according to a first embodiment of the present invention. In a positioning control mechanism 1A according to the first embodiment, reference numeral 2 denotes a main cylinder composed of a double-acting air cylinder; numeral 3 an air supply section for supplying pressurized air to the main cylinder 2; numeral 4 a main air circuit interposed between the air supply section 3 and the main cylinder 2; and numeral 5 a controller for electrically controlling the main air circuit 4.

The main cylinder 2 includes a first pressure chamber 11 and a second pressure chamber 12 that are formed on both sides of a piston 10, so that by supplying to the pressure chambers 11 and 12, the piston 10 is linearly reciprocated within the main cylinder 2. At one end of the piston 10, an operation rod 13 is connected to pass through the second pressure chamber 12 and extend outside from the end of the main cylinder 2. By the abutment of the operation rod 13, an action force is applied to a workpiece for conveying, chucking, or fabricating the workpiece.

At the other end of the piston 10 opposite to the operation rod 13, a length measurement rod 14 with a diameter and a cross-sectional area smaller than those of the operation rod 13 is connected to pass through the first pressure chamber 11 and extend outside from the end of the main cylinder 2, so that the length measurement rod 14 reaches the position of a length measurement sensor 6 added to the main cylinder 2. Then, by detecting the displacement of the length measurement rod 14 with the length measurement sensor 6, the active position of the piston 10 (that is, the operation rod 13) is to be measured along the whole range of the stroke. The position measurement signal is fed back to the controller 5 from the length measurement sensor 6.

The measurement of the active position is to be performed by magnetically, electrically, or optically reading the scale marked on the length measurement rod 14 with the length measurement sensor 6; however, the measurement system with the length measurement sensor 6 is not limited to the method using such a length measurement rod 14, so that other measurement methods may be used.

The air supply section 3 includes an air source 16 for outputting pressurized air; a filter 18 with a drain separator and an oil mist separator 19, which are connected in series along a supply flow path 17 communicated with the air source 16; and a regulator 20 composed of a pressure reducing valve with a relieving mechanism for maintaining air pressure at a set pressure.

The main air circuit 4 includes first and second air flow paths 23 and 24 connecting between the air supply section 3 and the first and second pressure chambers 11 and 12 of the main cylinder 2, respectively. Among them, in the first air flow path 23, a two-port first supply solenoid valve 25 is connected to intersect the first air flow path 23 and a two-port first exhaust solenoid valve 26 is connected at a position nearer to the first pressure chamber 11 than the first supply solenoid valve 25 to intersect the flow path between the first pressure chamber 11 and the atmosphere. In the second air flow path 24, a two-port second supply solenoid valve 27 is connected to intersect the second air flow path 24, and a two-port second exhaust solenoid valve 28 is connected at a position nearer to the second pressure chamber 12 than the second supply solenoid valve 27 to intersect the flow path between the second pressure chamber 12 and the atmosphere.

In the first and second air flow paths 23 and 24, speed controllers 30 are connected, respectively, each speed controller 30 having a variable restrictor 30a and a check valve 30b, which are connected in parallel with each other. The speed controller 30 is for adjusting the operating speed of the piston 10 by limiting the flow rate of the air flowing into or from the pressure chamber 11 or 12 with the variable restrictor 30a; however, the speed controller 30 is not always necessary.

The controller 5 is being electrically connected to the length measurement sensor 6 and the solenoid valves 25, 26, 27, and 28, and it includes inputting means 7 for inputting a target acting position of the piston 10. The inputting means 7 is for inputting the advance end position and/or the retreat end position of the piston 10, or the operating stroke of the piston 10 relative to the advance end or the retreat end as a reference, by the key, button, or volume operation. When the target position is inputted by the inputting means 7, the controller 5 compares the target position information with the position information measured by the length measurement sensor 6 so as to move the piston 10 to the target position and to stop it at the position for maintaining the stop state by on-off controlling the solenoid valves 25, 26, 27, and 28 on the basis of the compared results.

The control example by the controller 5 will be specifically described. When the advance end position and the retreat end position of the piston 10 are inputted by the inputting means 7 as target positions, the piston 10 is reciprocated between the advance end and the retreat end by the controller 5. In the advance process of the piston 10 from the retreat end to the advance end, both the first supply solenoid valve 25 and the second exhaust solenoid valve 28 are turned on, while the second supply solenoid valve 27 and the first exhaust solenoid valve 26 are turned off, so that the first pressure chamber 11 is communicated with the air supply section 3 while the second pressure chamber 12 is opened to the atmosphere. Thereby, to the first pressure chamber 11, pressurize air is supplied from the air supply section 3, so that the piston 10 and the rod 13 advance.

At this time, the acting position of the piston 10 is always measured by the length measurement sensor 6 via the length measurement rod 14 so as to be fed back to the controller 5 as the measured position information. Then, the controller 5 compares the measured position information with the target position information, and the above-mentioned control of the solenoid valves is continued until the deviation becomes zero.

When the piston 10 reaches the advance end and the deviation between the measured position information and the target position information becomes zero, both the first supply solenoid valve 25 and the second exhaust solenoid valve 28 are turned off by the controller 5. Thereby, the entire solenoid valves 25, 26, 27, and 28 are turned off, so that the first pressure chamber 11 and the second pressure chamber 12 are blocked off both the air supply section 3 and the atmosphere, and air is confined therewithin. As a result, the piston 10 is stopped at the advance end position and held in the stopped state.

Next, in the retreat process of the piston 10 from the advance end to the retreat end, by the controller 5, the second supply solenoid valve 27 and the first exhaust solenoid valve 26 are turned on while the first supply solenoid valve 25 and the second exhaust solenoid valve 28 are turned off, so that the second pressure chamber 12 is communicated with the air supply section 3 while the first pressure chamber 11 is opened to the atmosphere. Thereby, pressurized air is supplied to the second pressure chamber 12 from the air supply section 3, so that the piston 10 and the rod 13 retreat.

In also the retreat process, the acting position of the piston 10 is always measured by the length measurement sensor 6 and the length measurement rod 14 so as to be fed back to the controller 5 as the measured position information. Then, the controller 5 compares the measured position information with the target position information and the above-mentioned control of the solenoid valves is continued until the deviation becomes zero.

When the piston 10 reaches the retreat end and the deviation between the measured position information and the target position information becomes zero, both the second supply solenoid valve 27 and the first exhaust solenoid valve 26 are turned off by the controller 5. Thereby, the entire solenoid valves 25, 26, 27, and 28 are turned off, so that the first pressure chamber 11 and the second pressure chamber 12 are blocked off both the air supply section 3 and the atmosphere, and air is confined therewithin. As a result, the piston 10 is stopped at the retreat end and held in the stopped state.

In such a manner, according to the positioning control system described above, the acting positions of the piston 10 in a double-acting air cylinder can be optionally changed or adjusted depending on operation kinds with the simple positioning control mechanism composed of the length measurement sensor 6, a plurality of the two-port solenoid valves 25, 26, 27, and 28, and the controller 5 without any mechanical adjustment.

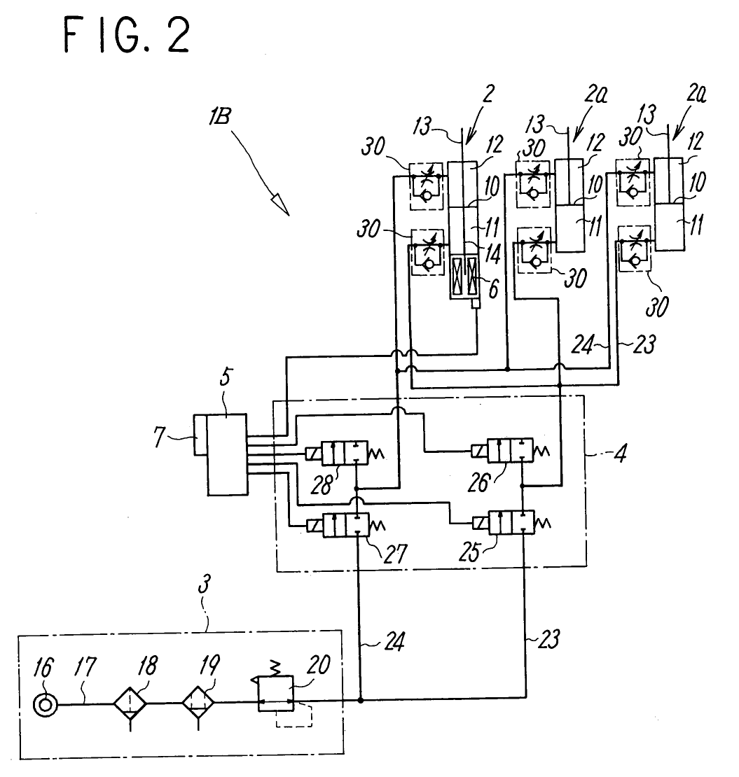

FIG. 2 shows a positioning control mechanism according to a second embodiment of the present invention. A positioning control mechanism 1B according to the second embodiment includes at least one double-acting slave cylinder 2a without the length measurement sensor 6 in addition to the main cylinder 2, the air supply section 3, the main air circuit 4, and the controller 5, which have the same configurations as those in the positioning control mechanism 1A according to the first embodiment. The slave cylinder 2a is connected to the main air circuit 4 in parallel with the main cylinder 2. By controlling the main air circuit 4 with the controller 5, the slave cylinder 2a can be synchronously position-controlled following the main cylinder 2.

Since the slave cylinder 2a has the same configuration and effect as those in the main cylinder 2 except for the point having no length measurement sensor, like reference characters designate like components common to the main cylinder 2, and the description of configuration and effect is omitted.

To the first air flow path 23 communicated with the first pressure chamber 11 of the slave cylinder 2a and to the second air flow path 24 communicated with the second pressure chamber 12, the speed controllers 30 may be connected, respectively, if necessary.

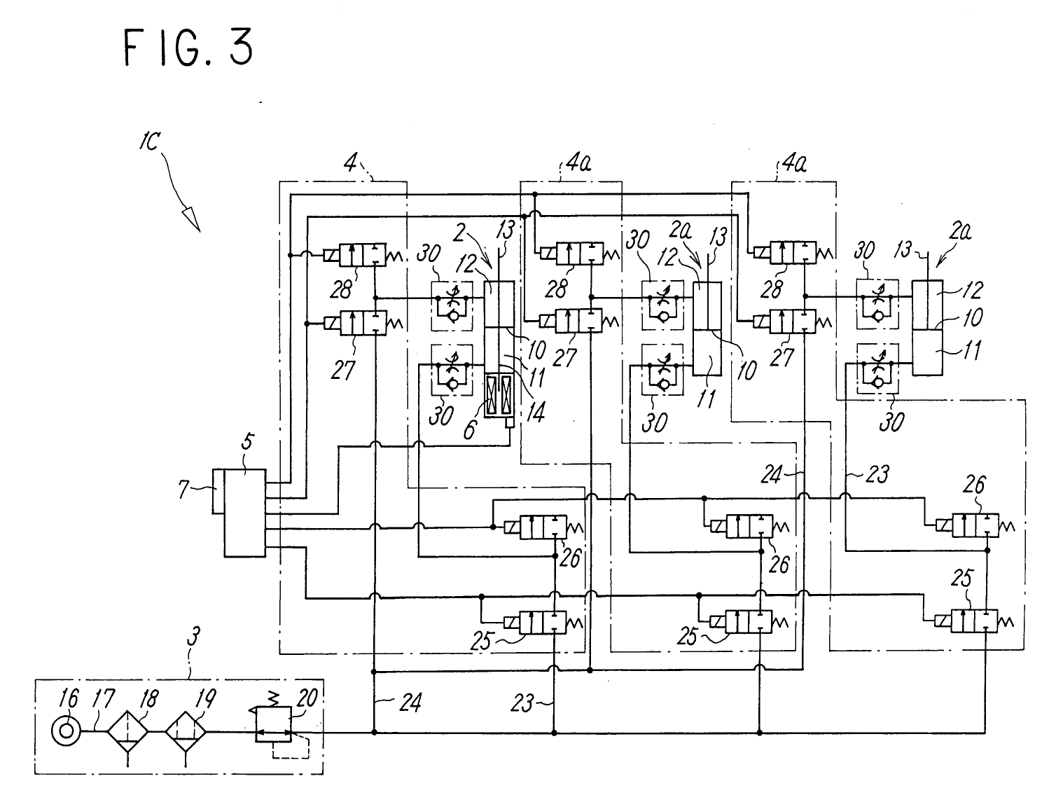

FIG. 3 shows a positioning control mechanism according to a third embodiment of the present invention. The point of a positioning control mechanism IC according to the third embodiment different from the positioning control mechanism 1B according to the second embodiment is that between each slave cylinder 2a and the air supply section 3, a slave air circuit 4a having the same configuration as that of the main air circuit 4 is connected in parallel with the main air circuit 4; and the first supply solenoid valve 25, the first exhaust solenoid valve 26, the second supply solenoid valve 27, and the second exhaust solenoid valve 28 of each slave air circuit 4a are electrically connected to the controller 5 in parallel with the first supply solenoid valve 25, the first exhaust solenoid valve 26, the second supply solenoid valve 27, and the second exhaust solenoid valve 28 of the main air circuit 4, respectively. Hence, also according to the third embodiment, with the controller 5, the slave cylinder 2a is synchronously position-controlled by the slave air circuit 4a following the main cylinder 2 and the main air circuit 4.

Since the configuration and effect of the third embodiment other than the above-mentioned point are substantially the same as those of the second embodiment, like reference characters designate like components common to the second embodiment, and the description of configurations and effect is omitted.

In the embodiments described above, the solenoid valves 25, 26, 27, and 28 in the main air circuit 4 or the slave air circuit 4a may be provided independently or may be grouped as a solenoid valve assembly. Alternatively, they may also be mounted on the corresponding the main cylinder 2 or the slave cylinder 2a. Furthermore, the controller 5 may be assembled in the main cylinder 2. Also, when the speed controllers 28 are provided, they may also be assembled in the corresponding the main cylinder 2 or the slave cylinder 2a.

1. A positioning control mechanism for a double-acting air cylinder comprising:
a double-acting main cylinder having a first pressure chamber and a second pressure chamber on both sides of a piston in that the piston is reciprocated by supplying air to these pressure chambers;
a length measurement sensor for measuring an acting position of the piston along the entire stroke of the piston;
an air supply section having an air source;
a main air circuit interposed between the air supply section and the main cylinder; and
a controller for electrically controlling the main air circuit,
wherein the main air circuit includes a first air flow path and a second air flow path connecting between the air supply section and the first and second pressure chambers of the main cylinder, respectively; a two-port first supply solenoid valve and a two-port second supply solenoid valve connected to the first and second air flow paths so as to intersect them, respectively; and a two-port first exhaust solenoid valve and a two-port second exhaust solenoid valve connected to the first and second pressure chambers so as to intersect the flow paths between the atmosphere and the first and second pressure chambers, respectively, and
wherein the controller includes inputting means electrically connected to the length measurement sensor and the solenoid valves for inputting a target acting position of the piston, and the controller is configured to move the piston to the target acting position and stop it at the position by on-off controlling the solenoid valves on the basis of the compared results between target position information inputted by the inputting means and measured position information measured by the length measurement sensor: when the piston is advanced, the first supply solenoid valve and the second exhaust solenoid valve are turned on, while the second supply solenoid valve and the first exhaust solenoid valve are turned off, so that the air supply section is communicated with the first pressure chamber, and the second pressure chamber is opened to the atmosphere; when the piston is backed, the second supply solenoid valve and the first exhaust solenoid valve are turned on, while the first supply solenoid valve and the second exhaust solenoid valve are turned off, so that the air supply section is communicated with the second pressure chamber, and the first pressure chamber is opened to the atmosphere; and when the piston is stopped at the target position and maintained at the stopped position, the entire solenoid valves are turned off so as to confine air within the both pressure chambers.

2. The mechanism according to claim 1, further comprising a double-acting slave cylinder with no length measurement sensor in addition to the main cylinder,
wherein the slave cylinder is positioning-controlled via the main air circuit following the main cylinder by being connected to the main air circuit in parallel with the main cylinder.

3. The mechanism according to claim 1, further comprising:
a double-acting slave cylinder with no length measurement sensor; and
a slave air circuit connected to the slave cylinder to have the same configurations as those of the main air circuit, in addition to the main cylinder and the main air circuit,
wherein the slave cylinder and the slave air circuit are positioning-controlled following the main cylinder and the main air circuit by being connected to the air supply section and the controller in parallel with the main cylinder and the main air circuit, respectively.

4. The mechanism according to any one of claims 1 to 3, wherein the air supply section includes a regulator for maintaining the air pressure at a set pressure.
